(19) United States
(12) Patent Application Publication
(10) Pub. No.: US 2008/0116781 A1
(43) Pub. Date: May 22, 2008

(54) FLAT PANEL DISPLAY APPARATUS

(76) Inventor: Kyu-Hang Lee, Yongin-si (KR)

Correspondence Address: CHRISTIE, PARKER & HALE, LLP, PO BOX 7068, PASADENA, CA, 91109-7068, US

(21) Appl. No.: 11/746,029

(22) Filed: May 8, 2007

(30) Foreign Application Priority Data
Nov. 20, 2006 (KR) 10-2006-0114685

(51) Int. Cl. H01J 63/04; H01J 17/49

(52) U.S. Cl. 313/484; 313/581

(57) ABSTRACT

A flat display panel includes a first substrate and a second substrate facing the first substrate. A barrier rib forms discharge cells by dividing the space between the first and second substrates. First and second electrodes cross each other at the discharge cells. Phosphor layers are formed in the discharge cells. Terminal lines extend from the first electrodes and form a terminal portion. Protruding portions formed on the terminal lines and protrude toward the adjacent terminal lines. The protruding portions of the terminal lines are alternately arranged with the protruding portions of the adjacent terminal lines.

### CROSS-REFERENCE TO RELATED APPLICATION

This application claims priority to and the benefit of Korean Patent Application No. 10-2006-0114685 filed on Nov. 20, 2006 in the Korean Intellectual Property Office, the entire contents of which are incorporated herein by reference.

### BACKGROUND OF THE INVENTION

1. Field of the Invention

The present invention relates to flat panel displays, and, in particular, to flat panel displays having a terminal portion connecting electrodes to a driving board.

2. Description of the Related Art

Flat panel displays can include plasma display panels which display an image using visible light generated by exciting phosphor layers using ultraviolet rays generated by plasma formed by a gas discharge. Since the plasma display can be large-sized with a high resolution, it is spotlighted as a next generation flat panel display.

A typical plasma display panel has a 3-electrode surface discharge structure. That is, a pair of electrodes are formed on a front substrate and an address electrode is formed on a surface of a rear substrate facing the front substrate. The combination of the electrodes corresponds to discharge cells.

More than several millions of unit discharge cells may be arranged in a matrix pattern in the plasma display panel. The plasma display panel selects discharge cells that will be turned on using the memory property of wall-charges and discharges the selected discharge cells, thereby displaying a desired image.

In order to control the above operation, the electrodes form a terminal portion at an end portion of the substrate. The terminal portion is connected to a driving board to apply a driving voltage to the electrodes.

However, as the resolution of the PDP increases, the number of terminal lines forming the terminal portion increases and thus gaps between the terminal lines need to be reduced. However, the gaps between the terminal lines need to be greater than a predetermined level required for the manufacturing process.

As the gaps between the terminal lines become reduced, the chance of occurrence of a short circuit between the terminal lines increases due to line migration.

### SUMMARY OF THE INVENTION

In accordance with the present invention embodiments of a flat display panel are provided in which as many terminal lines as possible can be arranged while still maintaining a minimum gap between the terminal lines.

In an exemplary embodiment of the present invention, a flat display panel includes a first substrate and a second substrate facing the first substrate. A barrier rib forms discharge cells by dividing the space between the first and second substrates. First and second electrodes cross each other at the discharge cells. Phosphor layers are formed in the discharge cells. Terminal lines extend from the first electrodes and form a terminal portion. Protruding portions are formed on the terminal lines and protrude toward adjacent terminal lines, wherein the protruding portions of one terminal line are alternately arranged with the protruding portions of an adjacent terminal line.

The protruding portions of the terminal line may be positioned between the protruding portions of the adjacent terminal line. The protruding portions of the terminal line may protrude toward both adjacent terminal lines. The protruding portions may be symmetrical with respect to a respective terminal line.

A line width d1 of the terminal line may be less than a line width d2 of a portion of the terminal line where the protruding portions are formed, but equal to or greater than ½×d2.

In another exemplary embodiment of the present invention, a plasma display panel includes a first substrate and a second substrate facing the first substrate. A barrier rib forms discharge cells by dividing the space between the first and second substrates. First and second electrodes cross each other at the discharge cells. Phosphor layers are formed in the discharge cells. First terminal lines extend from the first electrodes and form a terminal portion. Second terminal lines extend in parallel with the first terminal lines, wherein each of the first terminal lines is provided with protruding portions protruding toward both adjacent second terminal lines, and each of the second terminal lines is provided with recessed portions facing the protruding portions.

The protruding portions of the first terminal lines may be symmetrical with reference to a respective terminal line. The second terminal lines disposed at both sides of the first terminal lines may be symmetrical with reference to the first terminal lines.

The second terminal lines may form the recessed portions such that they are recessed away from the protruding portions of the first terminal lines and protrude toward portions defined between the protruding portions of the first terminal lines.

A distance P1 between the protruding portion of the first terminal and the recessed portion of the second terminal line may be same as a distance P2 between a portion between the protruding portions of the first terminal line and the second terminal line.

A line width t1 of a portion between the protruding portions of the first terminal may be same as a line width t3 of the recessed portion of the second terminal line.

In still another exemplary embodiment of the present invention, a plasma display panel includes a first substrate and a second substrate facing the first substrate. A barrier rib forms discharge cells by dividing the space between the first and second substrates. First and second electrodes cross each other at the discharge cells. Phosphor layers are formed in the discharge cells. Third terminal lines extend from the first electrodes and form a terminal portion. Fourth terminal lines extend in parallel with the third terminal lines, wherein each of the third terminal lines is provided with first and second protruding portions protruding toward both adjacent second terminal lines, the first protruding portions being alternately arranged with the second protruding portions, and each of the fourth terminal lines is provided with recessed portions facing the protruding portions.

The fourth terminal line may form the recessed portions such that they are recessed away from the protruding portions of the third terminal lines and protrude toward portions defined between the protruding portions of the third terminal lines.

A distance P1 between the protruding portions of the third terminal lines and the recessed portions of the fourth terminal lines may be the same as a distance P2 between a portion between the protruding portions of the third terminal lines and the fourth terminal lines.

A line width w1 of the third terminal lines may be less than a line width w2 of a portion of the third terminal lines where the protruding portions are formed, but equal to or greater than ½×w2.

A line width w1 of a portion between the protruding portions of the third terminal lines may be the same as a line width w3 of the recessed portions of the fourth terminal lines.

### BRIEF DESCRIPTION OF THE DRAWINGS

FIG. 1 is a plan view of a flat display panel according to an embodiment of the present invention.

FIG. 2 is an enlarged perspective view of a portion A of FIG. 1.

FIG. 3 is a partly enlarged plan view of an exemplary terminal portion of the address electrodes of FIG. 1.

FIG. 4 is a partly enlarged plan view of an exemplary terminal portion of address electrodes according to a second embodiment to the present invention.

FIG. 5 is a partly enlarged plan view of an exemplary terminal portion of address electrodes according to a third embodiment to the present invention.

### DETAILED DESCRIPTION

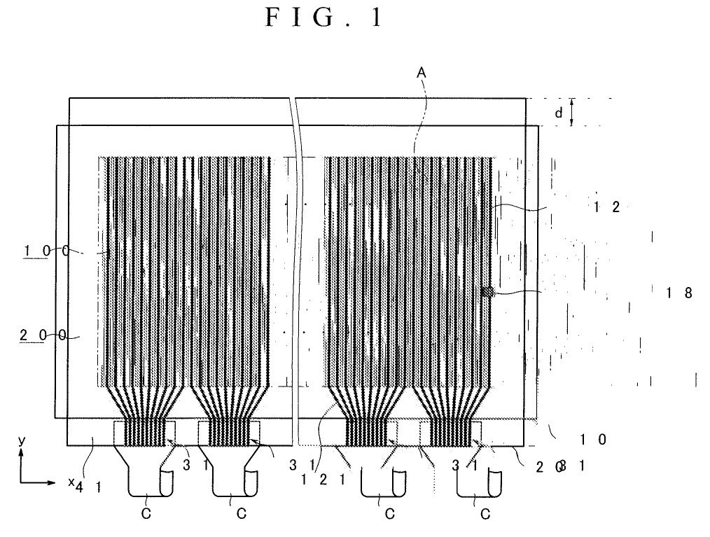

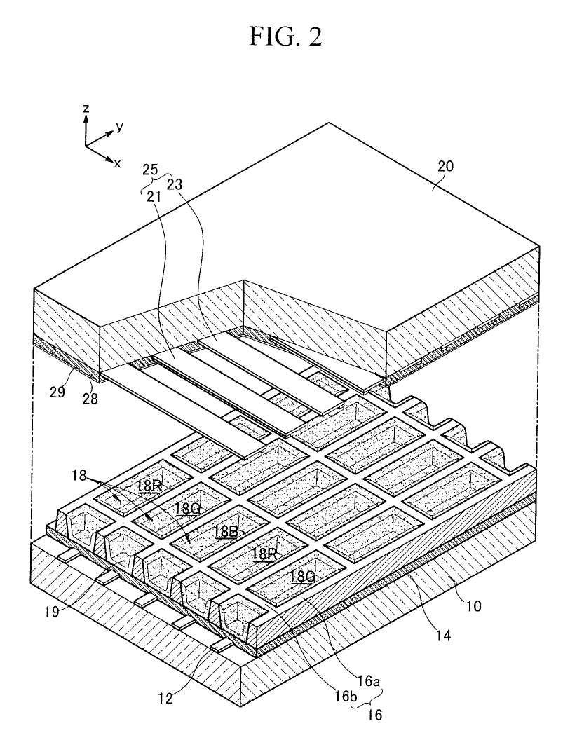

Referring to FIGS. 1 and 2, an exemplary embodiment of a plasma display panel version of a flat display panel includes rear and front substrates 10, 20 facing each other and spaced apart from each other. The rear and front substrates 10, 20 are sealed together, and barrier ribs 16 are disposed between the rear and front substrates 10, 20 to divide discharge cells 18 for the plasma discharge.

The plasma display panel is divided into a display region 100 and a non-display region 200. The discharge cells 18 are formed in the display region 100. The display region 100 is a portion where an image is substantially displayed by a plasma discharge of the discharge cells. The non-display region 200 is a portion where the image is not displayed. The non-display region 200 surrounds the display region 100.

Address electrodes 12 (hereinafter, also referred to as first electrodes) are arranged on a surface of the rear substrate 10 facing the front substrate 20. The first electrodes 12 extend in a first direction (the y-axis in FIG. 1) along the discharge cells 18. The first electrodes 12 cross display electrodes 25 (hereinafter, also referred to as second electrodes) formed on a surface of the front substrate 20 facing the rear substrate 10.

Referring to FIG. 2, the rear and front substrates 10, 20 face each other and the barrier rib 16 is interposed between the rear and front substrates 10, 20 to divide the discharge cells 18. Each of the discharge cells 18 defines a sub pixel that is a minimum unit for displaying the image. One pixel is defined by a plurality of sub-pixels.

The display and address electrodes 25, 12 are formed to correspond to the discharge cells 18. The display electrodes 25 are spaced apart from the address electrodes 12, and the display electrodes 25 extend in a direction crossing the address electrodes 12. The discharge cells 18 correspond to respective crossed regions of the display and address electrodes 25, 12.

The display electrodes 25 are formed on the front substrate 20. The display electrodes 25 may be formed of a pair of sustain and scan electrodes 23, 21. The scan electrodes 21 act with the address electrodes 12 to select the discharge cells 18 that will be turned on, and the sustain electrodes 23 act with the scan electrodes 21 to discharge the selected discharge cells 18.

The scan and sustain electrodes 21, 23 are disposed to face each other on an substantially identical plane, thereby forming a discharge gap therebetween.

The display electrodes 25 are protected by being covered by a dielectric layer 28 formed of dielectric, such as PbO, B₂O₃, and SiO₂ and the like. During discharge, the dielectric layer 28 prevents charged particles from colliding with the display electrodes 25, thereby preventing the display electrodes 25 from being damaged. The dielectric layer 28 may be covered by a passivation layer 29 formed of, for example, MgO.

The address electrodes 12 may be formed on a surface of the rear substrate 10 facing the front surface 20. As shown in FIG. 2, the address electrodes 12 extend in a direction (the y-axis of FIG. 2) along the discharge cells 18 to cross the display electrodes 25. The address electrodes 12 are arranged in parallel.

The address electrodes 12 are protected by a dielectric layer 14. The barrier rib 16 has first barrier members 16a extending along the y-axis and second barrier members 16b extending along the x-axis to divide the discharge cells 18.

Phosphor layers 19 for emitting visible light of each color are formed in the discharge cells 18. In order to display an image, the phosphor layers 19 may be red, green, and blue phosphors to provide red, green, and blue discharge cells 18R, 18G, 18B. A set of red, green, and blue discharge cells 18R, 18G, 18B defines one pixel.

A discharge gas that is a mixture gas of neon, xenon, and the like is filled in the discharge cells 18 which are provided with the phosphor layers 19.

With the above-described structure, an image is displayed by the discharge cells 18 in the display region 100.

Referring again to FIG. 1, the address electrodes 12 crossing the display electrodes 25 at the discharge cells 18 extend along the y-axis to form terminal portions 31 at an end portion of the front substrate 20.

The rear substrate 10 is sealed together with the front substrate 20 in a state where they cross each other. Therefore, an exposed region 41 is provided at an end portion of the front substrate 20. The exposed region 41 corresponds to the non-display region 200 of the plasma display panel. The address electrodes 12 formed along the discharge cells 18 in the display region 100 form the terminal portions 31 at the exposed region 41. Terminal lines 121 extending from the address electrodes 12 have gaps therebetween. The gaps between the terminal lines 121 are reduced as the terminal lines 121 pass through the non-display region 200 and further extend to the exposed region 41 to form the terminal portions 31.

The terminal portions 31 connect the address electrodes 12 to a driving board (not shown) which generates a driving voltage. The terminal portions 31 are electrically connected to a signal line “C”, e.g., a tape carrier package (TCP), to connect the address electrodes 12 to the driving board. The driving voltage for selecting the discharge cells 18 that will be turned on by acting with the scan electrodes 21 can then be applied to the address electrodes 12.

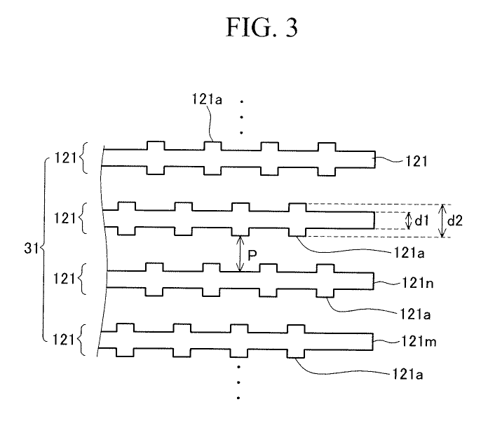

FIG. 3 shows a partly enlarged plan view of an exemplary terminal portion of the address electrodes in accordance with a first embodiment of the present invention. In first through third embodiments, representative terminal portions of the address electrodes are shown. However, concepts of the present invention can also be applied to terminal portions of other electrodes (e.g., scan electrodes).

Referring to FIG. 3, the terminal portions 31 of the address electrodes 12 are formed by the terminal lines 121 that are gathered together while extending from the address electrodes. The terminal lines 121 are disposed in parallel while maintaining a minimum gap “P” therebetween.

The terminal line 121n has protruding portions 121a protruding toward the adjacent terminal line 121m. The protruding portions 121a of the terminal line 121n are positioned between the protruding portions 121a of the adjacent terminal line 121m. A line width d2 which includes the protruding portions 121a may be substantially identical to that of the conventional terminal line.

As described above, since the protruding portions 121a of the terminal line 121n are positioned between the protruding portions 121a of the adjacent terminal line 121m, the gap “P” between the terminal lines 121n, 121m can be maintained substantially identical to the conventional art while reducing an actual gap between the terminal lines 121n, 121m.

Therefore, unlike the conventional stripe type terminal line that is not provided with the protruding portions, the minimum gap between the terminal lines required for the manufacturing process can be maintained while the number of terminal lines that can be disposed within a predetermined area can increase.

The terminal line 121n is symmetrically formed with reference to an extension line thereof so that the protruding portions 121a of the terminal line 121n are alternately arranged with the protruding portions 121a of the adjacent terminal line 121m.

When a line width d1 of the terminal lines 121 is reduced too much, there may be an open circuit of respective terminal lines 121. Therefore, in an exemplary embodiment the line width d1 of the terminal lines 121 is set to be less than the line width d2 but equal to or greater than a line width (½×d2) taking into consideration the possible contraction of the material of the electrodes during the manufacturing process.

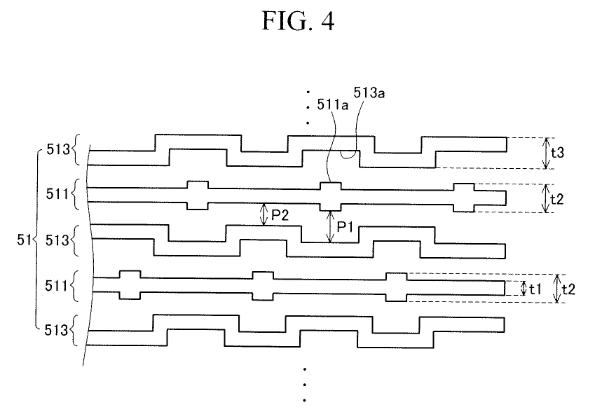

The following will describe a terminal portion of the address electrodes according to a second embodiment of the present invention with reference to FIG. 4.

Referring to FIG. 4, a terminal portion 51 includes first terminal lines 511 provided with protruding portions 511a and second terminal lines 513 provided with recessed portions 513a. The first terminal lines 511 are alternately arranged with the second terminal lines 513.

The protruding portions 511a of the first terminal lines 511 protrude toward the adjacent second terminal lines 513. The protruding portions 511a are symmetrically formed with reference to an extension line of the first terminal lines 511. That is, the protruding portions 511a protrude to both sides of the extension line of the first terminal lines 511.

When a line width t1 of the first terminal lines 511 is reduced too much, an open circuit may occur for respective first terminal lines 511. Therefore, the line width t1 of the first terminal lines 511 is set to be less than the line width t2 of portions where the protruding portions are formed but equal to or greater than a line width (½×t2) taking into consideration the possible contraction of the material of the electrodes during the manufacturing process.

The second terminal lines 513 have recessed portions 513a facing the protruding portions 511a of the adjacent first terminal lines 511.

The second terminal lines 513 are spaced apart from the adjacent first terminal lines 511 by a predetermined distance and extend in parallel with the first terminal lines 511. The second terminal lines 513 are formed such that recessed portions are recessed away from the protruding portions 511a of the adjacent first terminal lines 511 and protrude toward portions defined between the protruding portions 511a of the adjacent first terminal lines 511. That is, the recessed portions 513a of the second terminal lines 513 are formed to correspond to the protruding portions 511 a of the adjacent first terminal lines 511.

A distance P1 between the recessed portions 513a of the second terminal lines 513 and the corresponding protruding portions 511a of the adjacent first terminal lines 511 is the same as a distance P2 between portions between the adjacent protruding portions 511a of the first terminal lines 511 and the second terminal lines 513. These distances P1, P2 are minimum distances required for the manufacturing process.

As described above, since the recessed portions 513a of the second terminal lines 513 are formed to correspond to the protruding portions 511a of the adjacent terminal lines 511, the minimum distances P1, P2 required for the manufacturing process between the first and second terminal lines 511, 513 can be maintained substantially identical with the conventional art but the actual distance between them can be reduced.

Therefore, unlike the conventional stripe type terminal lines which are not provided with the protruding portions, the minimum gap between the terminal lines required for the manufacturing process can be maintained while the number of terminal lines that can be disposed within a predetermined area can increase.

In addition, since the protruding portions 511a of the first terminal lines 511 are formed to face the recessed portions 513a of the second terminal lines 513, the second terminal lines 513 are symmetrical with reference to the first terminal lines 511.

The line width t2 of the portions of the first terminal lines 511 where the protruding portions are formed is the same as the line width of the conventional terminal lines. A line width t3 of the portions of the second terminal lines 513 where the recessed portions 513a are formed is substantially identical to the line width of the conventional terminal lines.

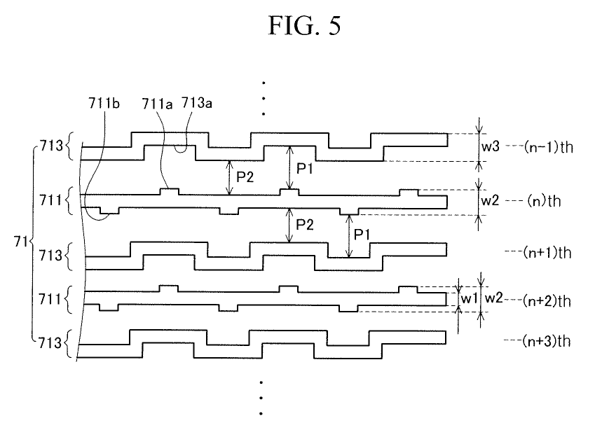

The following will describe a terminal portion of the address electrodes according to a third embodiment of the present invention with reference to FIG. 5.

As shown in FIG. 5, a terminal portion 71 includes third terminal lines 711 provided with first and second protruding portions 711a, 711b and fourth terminal lines 713 provided with recessed portions 713a. The third terminal lines 711 are alternately arranged with the fourth terminal lines 713.

The first and second protruding portions 711a of the third terminal lines 711 protrude toward the recessed portions 713a of the adjacent second terminal lines 513. For example, the first protruding potions 711a of the n^{th} terminal line 711 protrude toward the recessed portions 713a of the n^{th}−1 terminal line 713. The second protruding portions 711b of the n^{th} terminal line 711 protrude toward the recessed portions 713a of the n^{th}+1 terminal line 713. In addition, the second protruding portions 711b are positioned between the first protruding portions 711a. That is, the second protruding portions 711 b are alternately arranged with the first protruding portions 711a.

When a line width w1 of the third terminal lines 711 is reduced too much, an open circuit may occur for respective third terminal lines 711. Therefore, the line width t1 of the third terminal lines 711 is set to be less than the line width w2 of a portion where the protruding portions are formed but equal to or greater than a line width (½×w2) considering the contraction of the material of the electrodes during the manufacturing process.

In addition, the fourth terminal lines 713 are alternately arranged with the third terminal lines 711 such that the recessed portions 713a of the fourth terminal lines 713 face the first and second protruding portions 711a, 711b of the third terminal lines 711.

For example, the n^{th}−1 terminal line 713 is spaced apart from the n^{th} terminal line 711 by a predetermined distance and extends in parallel with the n^{th} terminal line 711.

The n^{th}−1 terminal line 713 is formed such that it is recessed away from the first protruding portions 711a of the n^{th} terminal line 711 and protrudes toward portions defined between the first protruding portions 711a of the n^{th} terminal line 711. That is, the recessed portions 713a of the n^{th}−1 terminal line 713 are formed to correspond to the first protruding portions 711a of the nth terminal line 711.

In addition, the n^{th}+1 terminal line 713 is spaced apart from the n^{th} terminal line 711 by a predetermined distance and extends in parallel with the n^{th} terminal line 711.

The n^{th}+1 terminal line 713 is formed such that it is recessed away from the second protruding portions 711b of the nth terminal line 711 and protrudes toward portions defined between the second protruding portions 711b of the n^{th} terminal line 711. That is, the recessed portions 713a of the n^{th}+1 terminal line 713 are formed to correspond to the second protruding portions 711b of the nth terminal line 711.

In addition, a distance P1 between the recessed portion 713a of the fourth terminal line 713a and the corresponding protruding portion 711a, 711b of the adjacent third terminal line 711 is same as a distance P2 between the third terminal line 711 and the adjacent fourth terminal line 713. Distances P1, P2 are minimum distances required for the manufacturing process.

As described above, since the recessed portions 713a of the fourth terminal line 713 are formed to correspond to the protruding portions 711a, 711b of the adjacent third terminal line 711, the minimum distances P1, P2 required for the manufacturing process between the first and second terminal lines 711, 713 can be maintained substantially identical with the conventional art but the actual distance between them can be reduced.

Therefore, unlike the conventional stripe type terminal lines not having the protruding portions, the minimum gap between the terminal lines required for the manufacturing process can be maintained while the number of terminal lines that can be disposed within a predetermined area can increase.

Further, the line width w2 of the portions of the third terminal lines 711 where the protruding portions are formed is the same as the line width of the conventional terminal lines. A line width w3 of the portions of the fourth terminal lines 713 where the recessed portions 713a are formed is substantially identical to the line width of the conventional terminal lines.

According to the above embodiments of the present invention, since the protruding portions of the terminal lines are alternately arranged with those of the adjacent terminal lines or are arranged to face the recessed portions of the adjacent terminal lines, an actual distance between the terminal lines can be reduced while maintaining a minimum distance required for the manufacturing process.

Although exemplary embodiments of the present invention have been shown and described, it will be appreciated by those skilled in the art that changes may be made in this embodiment without departing from the principles and spirit of the invention, the scope of which is defined in the claims and their equivalents.

For example, those skilled in the art can appreciate that while exemplary embodiments described herein relate to a plasma display panel, embodiments of the present invention are similarly applicable to various other flat panel displays, such as organic light emitting diode (OLED) displays, electron emission displays (EED), and the like. Also, for example, those skilled in the art can appreciate that while exemplary embodiments of the terminal lines described herein have straight-edged protrusions and recesses, such protrusions and recesses may be curvedly formed.

What is claimed is:

1. A plasma display panel comprising:
a first substrate;
a second substrate facing the first substrate;
a barrier rib dividing a space between the first substrate and the second substrate to form discharge cells;
first electrodes and second electrodes crossing each other at the discharge cells;
phosphor layers formed in the discharge cells;
terminal lines extending from the first electrodes and forming a terminal portion; and
protruding portions formed on the terminal lines and protruding toward adjacent terminal lines,
wherein the protruding portions of the terminal lines are alternately arranged with respect to the protruding portions of the adjacent terminal lines.

2. The plasma display panel of claim 1, wherein the protruding portions of the terminal lines are positioned between the protruding portions of the adjacent terminal lines.

3. The plasma display panel of claim 1, wherein the protruding portions of the terminal lines protrude toward both adjacent terminal lines.

4. The plasma display panel of claim 3, wherein the protruding portions are symmetrical with respect to a respective terminal line.

5. The plasma display panel of claim 1, wherein a line width of the terminal lines is less than a line width of a portion of the terminal line where the protruding portions are formed, but equal to or greater than ½ the line width of a portion of the terminal line where the protruding portions are formed.

6. The plasma display panel of claim 5, wherein the first electrodes are address electrodes.

7. The plasma display panel of claim 5, wherein the first electrodes are scan electrodes.

8. A plasma display panel comprising:
a first substrate;
a second substrate facing the first substrate;
a barrier rib dividing a space between the first substrate and the second substrate to form discharge cells;
first electrodes and second electrodes crossing each other at the discharge cells;
phosphor layers formed in the discharge cells;
first terminal lines extending from the first electrodes and forming a terminal portion; and
second terminal lines extending in parallel with the first terminal lines,
wherein each of the first terminal lines is provided with protruding portions protruding toward both adjacent second terminal lines, and
each of the second terminal lines is provided with recessed portions facing the protruding portions.

9. The plasma display panel of claim 8, wherein the protruding portions of the terminal lines are symmetrical with respect to a respective terminal line.

10. The plasma display panel of claim 9, wherein the second terminal lines disposed at both sides of the first terminal lines are symmetrical with respect to respective terminal lines.

11. The plasma display panel of claim 8, wherein a line width of the first terminal lines is less than a line width of a portion of the first terminal lines where the protruding portions are formed, but equal to or greater than ½ the line width of a portion of the first terminal lines where the protruding portions are formed.

12. The plasma display panel of claim 8, wherein the second terminal lines have the recessed portions recessed away from the protruding portions of the first terminal lines and between the protruding portions of the first terminal lines.

13. The plasma display panel of claim 8, wherein a distance between the protruding portions of the first terminal lines and the recessed portions of the second terminal lines is the same as a distance between protruding portions of the second terminal lines and recessed portions of the first terminal lines.

14. The plasma display panel of claim 8, wherein a line width of portions between the protruding portions of the first terminal lines is the same as a line width of the recessed portions of the second terminal lines.

15. The plasma display panel of claim 14, wherein the first electrodes are address electrodes.

16. The plasma display panel of claim 14, wherein the first electrodes are scan electrodes.

17. A plasma display panel comprising:
a first substrate;
a second substrate facing the first substrate;
a barrier rib forming discharge cells by dividing a space between the first substrate and the second substrate;
first electrodes and second electrodes crossing each other at the discharge cells;
phosphor layers formed in the discharge cells;
first terminal lines extending from the first electrodes and forming a terminal portion; and
second terminal lines extending in parallel with the first terminal lines,
wherein each of the first terminal lines is provided with first protruding portions and second protruding portions protruding toward both adjacent second terminal lines, the first protruding portions being alternately arranged with the second protruding portions, and
each of the second terminal lines is provided with recessed portions facing the protruding portions.

18. The plasma display panel of claim 17, wherein the second terminal lines have the recessed portions recessed away from the protruding portions of the first terminal lines and protruding toward portions between the protruding portions of the first terminal lines.

19. The plasma display panel of claim 17, wherein a distance between the protruding portions of the first terminal lines and the recessed portions of the second terminal lines is the same as a distance between portions between the protruding portions of the first terminal lines and the second terminal lines.

20. The plasma display panel of claim 8, wherein a line width of the first terminal lines is less than a line width of portions of the first terminal lines where the protruding portions are formed, but equal to or greater than ½ the line width of portions of the first terminal lines where the protruding portions are formed.

21. The plasma display panel of claim 17, wherein a line width of portions between the protruding portions of the first terminal lines are the same as a line width of the recessed portions of the second terminal lines.

22. The plasma display panel of claim 21, wherein the first electrodes are address electrodes.

23. The plasma display panel of claim 21, wherein the first electrodes are scan electrodes.

24. A flat panel display apparatus comprising:
a flat display panel, the flat display panel having electrodes in a display area, the electrodes being coupled to terminal lines extending from the display area to a non-display area,
wherein the terminal lines are collected in a terminal area portion of the non-display area for coupling to driving board signal lines,
wherein each terminal line in the terminal area has a protruding portion and a recessed portion, each protruding portion being separated from a corresponding recessed portion of an adjacent terminal line by a gap.

25. The flat display apparatus of claim 24, wherein the flat display panel is a plasma display panel.

26. The flat display apparatus of claim 24, wherein protruding portions alternate with recessed portions along a terminal line.

27. The flat display apparatus of claim 24, wherein a terminal line has a line width and a protruding portion has a corresponding recessed portion located adjacent to the protruding portion along the line width.

28. A method for avoiding short circuits between adjacent terminal lines on a flat panel display substrate comprising forming each terminal line to have protruding portions and recessed portions, each protruding portion being separated from a corresponding recessed portion of an adjacent terminal line by a gap.

29. The method of claim 28, further comprising alternating protruding portions with recessed portions along a terminal line.

30. The method of claim 28, wherein a terminal line has a line width and a protruding portion has a corresponding recessed portion located adjacent to the protruding portion along the line width.

31. A method of collecting terminal lines on a flat panel display substrate, comprising:
locating a terminal area at an end of the substrate;
directing the terminal lines into the terminal area; and
forming each terminal line in the terminal area to have protruding portions and recessed portions, each protruding portion being separated from a corresponding recessed portion of an adjacent terminal line by a gap.

32. A terminal collector for a flat display panel substrate, comprising:
a terminal area located at an end of the flat display panel substrate; and
terminal collector lines located in the terminal area for coupling terminal lines from flat display panel electrodes to driving board signal lines,
wherein each terminal collector line has protruding portions and recess portions, each protruding portion being separated from a corresponding recess portion of an adjacent terminal collector line by a gap.
